(19) United States
(12) Patent Application Publication
(10) Pub. No.: US 2011/0302629 A1
(43) Pub. Date: Dec. 8, 2011

(54) Systems And Methods For Secure Network Interoperability and Management

(76) Inventors: Andrea L. Whitson, Pace, FL (US); James Michael Teal, West Newbury, MA (US); Dale Carruth, Nashua, NH (US); Thomas James Alexander Campbell, Camden, ME (US)

(21) Appl. No.: 12/985,332

(22) Filed: Jan. 5, 2011

Related U.S. Application Data
(60) Provisional application No. 61/292,418, filed on Jan. 5, 2010.

(51) Int. Cl. G06F 21/00

(52) U.S. Cl. 726/3

(57) ABSTRACT

The invention relates to an interoperability system that provides increased security and data tracking to security intensive applications, such as transportation systems that currently utilize a large number of independent devices and related systems.

### REFERENCE TO RELATED APPLICATIONS

This patent application claims the benefit of U.S. Provisional Application No. 61/292418 filed on Jan. 5, 2009, the disclosure of which is incorporated herein by reference in its entirety.

### BACKGROUND OF THE INVENTION

1. Field of the Invention

The present invention relates generally to interoperability systems and, more particularly, to interoperability of transportation security systems that may or may not be networked, and to management of devices employed by such security systems.

2. Description of Related Art

Air traffic security and the security of the travelling public and their associated parcels and baggage need a more cohesive approach or system to provide the level of visibility and actionable intelligence needed to support the enhanced, complex, multifaceted threats in the current operating environment.

Collectively, the travelling public, see the Airport Security equipment (baggage scanners, metal detectors, contra-band scanners, explosive scanners, millimeter wave scanners, etc) as a System, but in many ways, the deployment and use of such equipment is generally not managed or easily accessed as a cohesive system, but as a complex system of systems with little to no interoperability between models of equipment or across vendors.

Some interoperable systems provide for monitoring of devices connected to isolated subnetworks or subsystems. By way of an example, U.S. Pat. No. 6,707,879 to McClelland et al. (2004) discloses a system for remote inspection of luggage items in a luggage processing system at an airport. Another system for remote access and analysis of data collected about items under inspection, such as items passed through an X-ray machine, is described in U.S. Patent Application Publication No. 2006/0115109. These systems, however, may not communicate data securely. Moreover, the operation of these systems may require substantial modification of systems to which appliances are connected. Finally, conventional systems are not scalable, because they require the modifications stated above.

U.S. Pat. No. 7,424,736 to Cook, III et al. discloses a system for creating directed circuits including encoding of policy and state information associated with directed circuits that may be established between two network entities on separate protected networks. The invention disclosed in the present application utilizes the technology disclosed in the U.S. Pat. No. 7,424,736 and extends the concept of virtualizing the service infrastructure to the interoperability systems including but not limited to transportation security systems.

The invention disclosed in the present application is intended to support a means of providing secure access in a timely fashion to a broader constituency of users. It is believed that a more informed Network Operations Center (NOC) and Security Operations Center (SOC) are able to operate more effectively and efficiently with the advent of multiple vector attacks. By expanding the scope of visibility from a level of granularity as low as individual security devices, to security lanes at a check point to all lanes at a checkpoint to even higher levels of multiple check points in a terminal to multiple terminals and possibly even regional operations, the present invention is able to provide unprecedented insight into the security landscape. Through transformation and aggregation of information from disparate vendors and locations into a common message formats (Common Object Data Model) that are time correlated, the present invention is able to deliver valuable information about the security profile of the facility at any point in time.

### SUMMARY OF THE INVENTION

In a system according to the present invention, the problems associated with the systems known in the art, described above, are overcome by providing, in part, a secure connection mechanism, and a common data source that may be shared by various subsystems, without requiring a substantial modification of those systems.

The interoperability system according to the present invention comprises Network Operations Center (NOC), Security Operations Center (SOC), and virtual service infrastructure network (VSI). The virtual service infrastructure network allows the interoperability system to oversee the security systems including but not limited to transportation security system that may or may not be networked.

In one embodiment according to the present invention, the interoperability system provides Roles Based Access Controls (RBAC) for access and control of disparate security devices, spanning multiple vendors, building locations, and remote locations as if they were on a shared local network, but with addition access controls that support the diverse needs and requirements of varied user constituency groups. Unlike traditional commercial applications, systems known in the art, generally have more diverse user constituency groups including System Management (IT), Network Operations Security at a centralized NOC, Physical Passenger and Baggage Security Operations at multiple levels, Remote Vendor Diagnostics and service, and external regulatory and oversight governing bodies to name a few. The security devices from multiple vendors, which are natively networkable but are traditionally not networked together on a shared network, RBAC must be employed to ensure that user constituency groups who require access to specific vendor platforms (Hardware Providers and System Integrators) but not other vendor hardware platforms are only granted access to the specific devices, and network communications protocols that are appropriate for their prescribed use and those uses are recorded for auditing purposes.

Likewise, the RBAC mentioned above must be employed to ensure that user constituency groups who require access to specific operational performance data (number of available devices, number of bags/hour, number of passengers per hour, number of bag rescans, etc) or management features of the devices to control internal counters, set system level date and time, update firmware revisions, update software revisions, and update operating thresholds or algorithms and the like, can obtain such access without providing access to other data sources or facilities of the endpoint device using network communications protocols that are appropriate for their prescribed use and those uses are recorded for auditing purposes.

In another embodiment, wherein legacy/non-networkable security devices from multiple vendors, which are non-natively networkable and are traditionally not available on a shared network, a combination of hardware bridging of PLC or RS-232/RS-422 to secure TCP/IP based communications to provide RBAC must be employed to ensure that user constituency groups who need configuration and operational performance details from said devices can obtain such access without providing access to other data sources or facilities of the endpoint device using network communications protocols that are appropriate for their prescribed use and those uses are recorded for auditing purposes.

The interoperability system according to the present invention provides a unified view of data collected from disparate sources. Security Systems, known in the art, do not natively support a common object data model for ‘business objects’ related to passengers, bags, and cargo being processed for transportation across hardware vendors and platforms. The software will use a combination of traditional middleware tools functionality and proprietary transformations to enable the data collected from the disparate sources into a homogenous Common Object Data Model where existing industry standards do not exist. In one embodiment, wherein vendor devices are capable of a networked connection and data supporting multiple business objects must be collected and transformed to support the needs of the varied user constituency in a secure and auditable manner. In another embodiment, wherein vendor devices are not natively capable of a networked connection and data supporting one or more business objects must be collected and transformed to support the needs of the varied user constituency in a secure and auditable manner.

The interoperability system according to the present invention also provides access to collected information using tools known in the art of ITAM (IT Asset Management) and Network Operations. Data collected and transformed into a common data object model as discussed above may have alternative uses in Commercial-Off-The-Shelf (COTS) applications that leverage prevailing network management standards like SNMP.

In one embodiment, wherein data collected from natively networkable devices and in another embodiment, wherein non-natively networkable devices where data collected and transformed can be reused or repurposed and presented to COTS applications using prevailing standards, enabling standard COTS applications to access information and events that would not have been previously enabled for such access.

The interoperability system of the present invention further has the capability to assess potential threats by implementing complex event processing capabilities to enable additional operational and security analysis. In one embodiment, wherein data of disparate types or sources (Staff Schedule, User Logins, Login Failures, Multiple Location logins, Building Access Controls, System Configuration Changes etc) are used to assess potential threats beyond the scope of a single passenger or parcel passing through the system which is the current scope of the devices and software of the art today.

In another embodiment, wherein data of disparate types or sources can be correlated to external data sources through dynamic links. In this embodiment, an “Alert” may be generated if a staff member is not scheduled to be on shift, has not passed through the access control system, and the UserID has an unsuccessful login attempt. This alert could generate a link to Digital Video Surveillance system, to look at the grouping of cameras in the area of concern at that point in time. In this use case, the security data is collected by the system, but the Surveillance system data is not, but a ‘pathway’ is define to quickly link to the relevant information in that system.

In operation, according to one embodiment, a method of advance baggage screening may comprise steps of transmitting a threat file corresponding to an item under inspection to a processing center, analyzing the threat file according to a detection algorithm at the processing center to determine a screening result for the item under inspection, and transmitting the screening result to an operator interface for access by an operator.

According to another embodiment, a method of remote baggage screening may comprise steps of examining an item under inspection at a first location, storing information about an item under inspection obtained during the examining step, and linking a unique item identifier to the information to uniquely associate the information with the item under inspection. The method may also include steps of transmitting the information to a second location responsive to a request for the information, analyzing the information according to a detection algorithm to produce threat information, and determining a screening result for the item under inspection based on the threat information.

According to yet another embodiment, a method of advance baggage screening comprises steps of obtaining information about an item of baggage at a first point of inspection of the item of baggage, storing the information in a database, remotely accessing the information from a location other than the first point of inspection of the item of baggage, and analyzing the information to determine a screening result for the item of baggage. In one example, the step of obtaining information about the item of baggage may include performing an X-ray inspection of the item of baggage, and obtaining an image file that includes data corresponding to the X-ray image of the item of baggage and a unique item ID that uniquely identifies the item of baggage associated with the image file.

The invention and various embodiments and features may be better understood by reference to the following detailed description.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a diagram showing a vendor independent access for security equipment network segment.

FIG. 2 is a schematic block diagram of an embodiment where a security appliance is connected to operational networks via network connections.

FIG. 3 illustrates how interoperability solution set (DMI Core™) allows diverse and legacy systems from a variety of vendors to work together (i.e. inter-operate) and provides management interfaces for multiple stakeholders, simultaneously.

FIG. 4 is a flow diagram showing that DMI Core™ provides the Transportation Security (TranSec) customer a single interface for asset data and management.

### DESCRIPTION OF THE PREFERRED EMBODIMENT

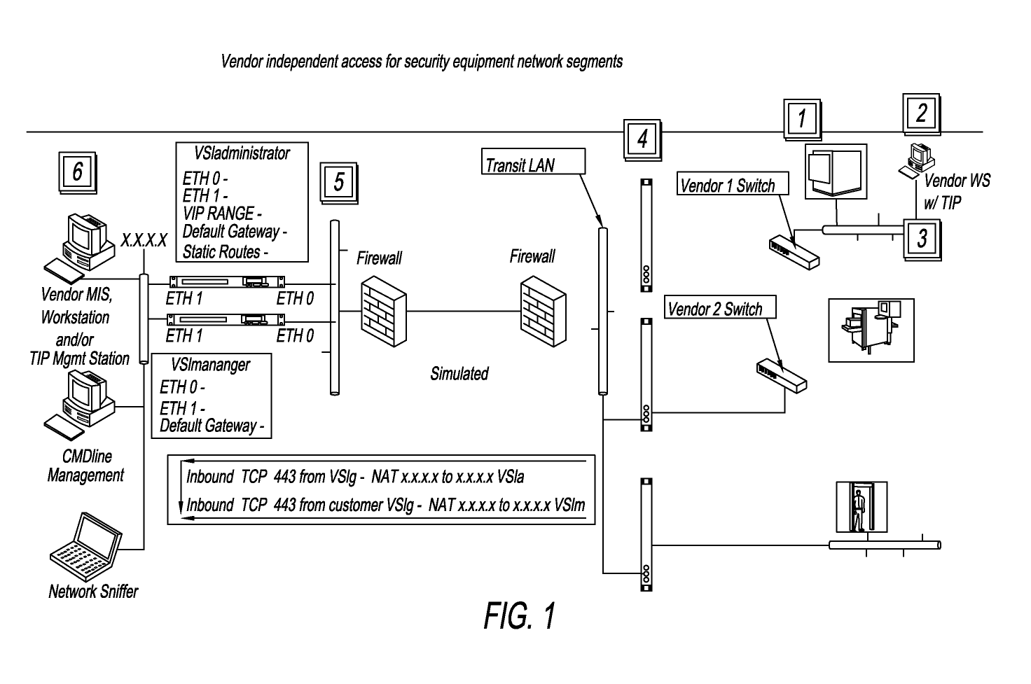

With reference to FIG. 1, according to one embodiment of the invention, a system is provided where a number of security appliances 1 and workstations including management workstations 2 are optionally connected via a network that may be of an arbitrary or proprietary network architecture. A VSI gateway™, a software available from ILS Technology, LLC, or analogous device with network sniffing and automated NAT technology 4 resides logically on that network 3 and also logically on another network 5 connected to a remote location where the automated NAT technology allows for a vendor device 6 to act as if it were co-located with the security devices and workstations 1 and 2 on the remote network 3.

A system as described above is provided where management of the security assets is accomplished via a vendor device or workstation 6 that is physically located in an operations center and physically connected via a network 5 and logically also connected to a remote network 3 via a NAT where the vendor-specific asset—through NAT—acts as if it is collocated with the remote security asset network segment 3 in order to manage security functions such as TIP library management, TIP user profile information, user/operator log in, and other normative managerial tasks that are typically performed local to the network segment 3.

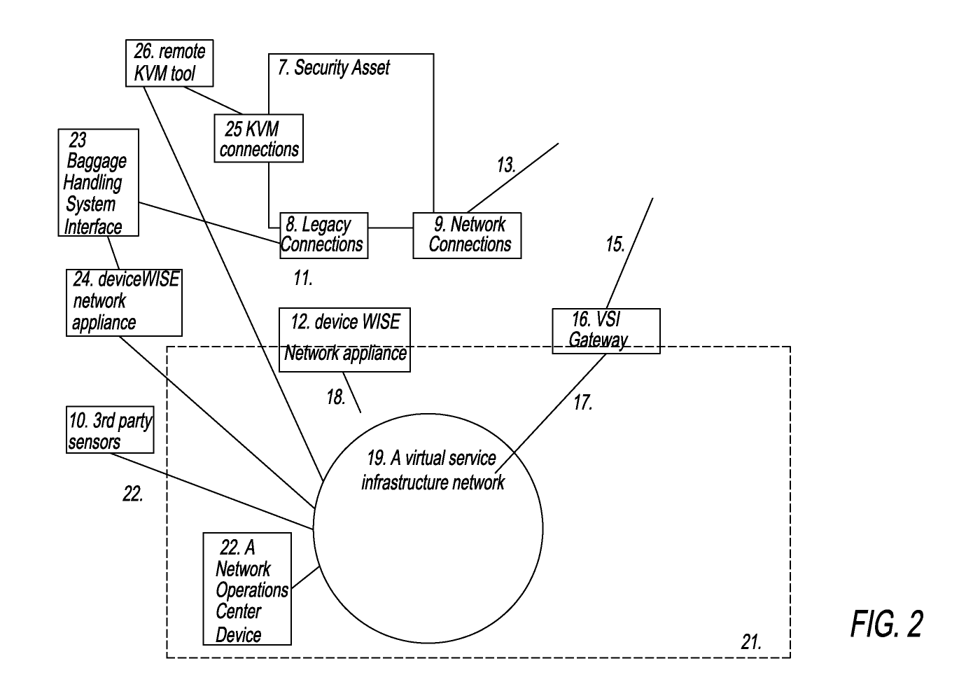

In one embodiment (referring to FIG. 2), a system is provided where a security appliance such as a baggage or personnel scanning device 7 is connected to an operational network 14 via one network connection 13, where it reports one subset of operational data and receives one subset of operational instructions. The security appliance is also connected via a legacy connection 8, such as a PLC or dry-contact relays at a customer interface, to a baggage handling system 23 where it receives a certain subset of operational information such as the IATA bag tag license plate and transmits a certain subset of operational data such as the IATA bag tag license plate, the algorithm decision for each bag, the operator decision for each bag, and the x-ray device status information (such as .system ready., .x-ray on., etc.), where information is collected from both: (A) the operational network 14 messages via a VSI gateway™ 16 or other device that incorporates both NAT and sniffer technology; and (B) an ILS deviceWISE™ network appliance 12 that collects up messages relayed to and from the baggage handling system. That information is associated together via a relational database, xml taxonomy, or other data object model such as MIMOSA. That information is made available for use by one or more Network Operations Center Devices 22 on a virtual service infrastructure network 19.

One such use would be the association of the IATA bag tag license plate (from 23) with the serial number of the security asset 7 that inspected it, the algorithm and operator decisions (from 8 or 9) related to screening the baggage item, the offset between NOC network time 19??? and system time on the security asset 7, and the location of the image file stored remotely on the security asset 7, such that an operator could query a database residing on an NOC 22 for the route a baggage item took through an airport and all associated images and operator and algorithm decisions associated with the baggage item.

In another embodiment, the system could be configured as above, but third party sensor 10 data may also be incorporated into the NOC 22 via the Virtual Service Infrastructure network 19, for the purpose of providing additional information about either asset performance (e.g., temperature, humidity, power quality, etc.) or the processing of passengers, baggage, and cargo items through the airport (e.g., using additional bag tag readers).

One such use of the above system could be to place a third party barcode scanning device physically next to a passenger screening location. Prior to the passenger screening their carry on items, an operator may scan the passenger's ticket so that their IATA passenger barcode is entered into the system along with a date, time and location. The passenger then sends their hand carry items through the x-ray scanner and steps through the metal detector portal. The passenger may scan their ticket at the end of their bags being processed by the x-ray device to signal the beginning and end of all items to be associated with that passenger. The NOC computer 22 knows the time offset (if any) between the barcode scanner, the metal portal, the x-ray scanner and network time on the virtual service infrastructure network 19. The NOC computer is able to associate the passenger with the results of the metal portal screening and the images, algorithm and operator decisions for each image of hand-carry luggage screened by the associated x-ray scanning device between the beginning and end scans of the passenger ticket barcode.

In another embodiment, the invention relates to a combination of the systems described above, where the data is associated in order to give a complete view of the security operations of the airport. For example, the data is formatted in a common data object model such as MIMOSA or NIEM to aid in interoperable use of the data. That interoperable use of the data can be made available to a number of NOC systems 22, such as Commercial-off-the-Shelf (COTS), military and proprietary systems for simultaneous use of the data.

In another embodiment, the network traffic and operational status of the networks (1,3,14,17) and security assets can be monitored for opportunities for managerial interaction with the devices under management, so that the negative impact to nominal operation of the assets in their role as security scanning devices is minimized. The interaction with that equipment can be managed by a NOC 22 and a request to interact with a device can be submitted to software that resides on the NOC 22 or a similar device. In a high security application, that request must be approved by someone different than the requester and the type of access requested determines the level of approval required for access to be granted. In one embodiment, the software randomly selects from a list of personnel at the appropriate level for submission and approval of the request, so that compromise of a single person with clearance to request access does not allow the overall system to be compromised.

To defeat such a system, a person would have to compromise a requestor and each and every person on the randomized list at the appropriate level of clearance in order to be certain that access is granted.

According to another embodiment, an encrypted key can be added to messages communicated between any of the components of the system in order to verify the source of the information. For example, the message that contains the IATA bag tag license plate number, the algorithm and operator decisions regarding a bag can be communicated from the Security System 7 to the Baggage Handling System 23 by any combination of intervening means is configured to contain a digital signature that verifies the origin of the message. That message may be verified by the receiving system or, the receiving systems may have no means of verifying the digital software (in the case of legacy systems, for example) and software operating on the VSI network may collect up all messages and digital signals and perform the verification separate from the normative operation of the security systems and their networks.

In the case of legacy systems, there may be no means to add the digital signature to the messages passed between systems. In this case, hardware and software on the virtual service infrastructure network may perform the following steps: (1) detect that a message is being sent from one device to another; (2) access the sending device and verify the identity of the system (for example, via the Windows operating system's ability to report the unique mother board identifier of a system); (3) check files resident on the system (for example, the Windows sys log or a proprietary log file) to validate the content of the message as sent and the identity of the sending system.

The system can then send signed messages in proxy for a legacy security system. When an invalid digital signal is detected, the system raises an alarm local to the machine (for example, an LED or audible alarm) and at remote locations via a coordinated plan previously expressed as a security policy or plan and resident in system software either distributed throughout the system and/or resident on the NOC 22 connected to the virtual service infrastructure 19. That alarm can be configured to contain the unique identifier for the passenger and/or the baggage or cargo item (such as the IATA bag tag license plate). That alarm can be forwarded to at least the next location in the airport where the baggage, cargo item or passenger is destined, so it may be intercepted.

A message (such as a status message relating to the operation of a machine, or messages carrying other information) handled by a communication system can be configured in the following way. A system, such as the VSI gateway™ 16 or a deviceWISE™ 12 appliance with network sniffing or message logging technology on board, can be attached to an operations security system or network of security systems. The system is used to collect various messages during operational events. For example, the messages communicated by the machine as it scans a bag are collected. Then, the messages communicated by the machine when it is in a fault condition are collected. A unique template for a given event (e.g., a bag scan or a machine fault) is generated from the pattern of messages. The template can be used to generate a simplified signal that relates to the given event. The template is used during the continuous operation of the security system to create that simplified signal whenever that pattern of messages is observed. The simplified signal is communicated via a standard messaging language, such as Simple Network Management Protocol (SNMP) or MIMOSA. The simplified signal is used via a NOC center 22 to inform a centralized system or a collection of NOC systems about the operational status of the devices under management via graphical display or data entry.

The structure of the template can be modified and perfected over time via a means for the user to edit the template, for example by manually adding or subtracting from the components of the template. In one embodiment, extraneous messages may be removed from the template and/or third party sensor information may be added to the template to improve performance. Alternatively, the simplified signals generated by the use of the template are compared with a separate source for recording the actual security device events and the total messages communicated.

A statistical programming package can be used to demonstrate correlation between messages and security system events. For example, a failed attempt for unauthorized access to a single device might raise no alarm and most likely represents no threat. Several failed attempts to access devices sequentially on the system or sequentially on a number of separate systems most likely represents an ongoing soft attack on the assets and a very high level of alert should be triggered in the control room. Alternatively, the system can represent a rising threat level with each successive attempted access. In another example, a customer paying cash in a country on a designated watch list for a ticket to another designated watch list country might not raise an alarm. A customer paying cash for a ticket in such a country who has a transfer to the US and whose bag failed an algorithm scan on a scanning device should raise an alarm. That alarm should be additionally escalated if there are other results associated with that passenger, for example if there is a soft-attack on the scanning device that is currently scanning his bag or if that device has been accessed for maintenance in any unusual way (for example, during peak operation via a policy override) during the preceding 24 hours.

In another embodiment, a fuzzy-clustering or adaptive-neuro fuzzy inference system (ANFIS) can be used to perfect the performance of the templates in question when compared to the record of actual events. A third party sensor information may optionally be correlated to the events relating to the operation of the security systems and network of security systems. That correlated data can be standardized and associated via a common data object model such as MIMOSA. That correlated data may be further utilized in an asset management system in order to predict the performance, remaining life, and upcoming maintenance needs of the systems.

Remote management of the system can be provided by accessing a Keyboard Video and Mouse system (KVM) (25 and 26) connected to the security device in question, instead of accessing the device itself. In one embodiment, any use of the KVM tool 26 automatically results in an access request being made through a central policy administrator and authorization of the access is made by an approved individual on a level appropriate to the security of the device in question. Optionally, the security of a legacy device is improved by disabling the factory default KVM interface and making KVM capabilities available only through the above protocol.

Alternatively or additionally, the system where the security of a legacy device is improved by physically connecting a locking mechanism (such as a card-swipe connected lock) to the surface of a system to prevent access to the device and an access request (such as a card swipe local to the machine) results in an access request being made through a central policy administrator. Authorization of the access is made by an approved individual on a level appropriate to the security of the device in question.

A DMI Transportation Security (TranSec) interoperability solution set (DMI Core™) allows diverse and legacy systems from a variety of vendors to work together (i.e. inter-operate) to deliver responsive, auditable and secure integration with either DMI-sourced or COTS management interfaces for multiple stakeholders, simultaneously. The invention provides a unified means of addressing devices in a vendor-independent manner. This system reports and responds to multiple systems, each optimized for the role-based managerial tasks for each discipline represented in the incident response and operations management teams.

This interoperability system may be provided securely (up to FIPS Level 4) via an ILS Virtual Service Infrastructure (VSI) without impact on network latency or packet loss for operational security network segments. The system “listens” to isolated networks or non-networked systems and reports status messages and alarms back to a unified, vendor-neutral operations data source via a network separated from the asset network at OSI-layer 1 or 2. A data source can be a database to which each application can have access. This would require every application to line up its requests for data and wait for the database application to run its query. The database may be centralized or the centralized data source can be a broadcast source. For example, the system can broadcast xml data (via an xml “push” operation to waiting applications) or the system can transmit messages in SNMP and SNMP traps. Thus, the centralized data source broadcasts data in a standard format as it is received or after an intermediate translation is performed and various applications listen for those messages to which it is appropriate for them to respond. In this way, as an example, the IT personnel may look for messages (via IT asset management tools) related to the switches, packet traffic, etc. The security personnel may listen (via C3I tools) for security-related messages. It is a single source of data used in different ways by different groups in the airport or across several airports or transportation systems. Thus, status messages are relayed without impact to the operational network. The resulting system is readily scalable to tens of thousands of devices, managed at multiple locations, geographically remote from the operations center.

When an asset must be individually managed, queried or manipulated, a FIPS-certified Directed Circuit™ secure tunnel technology with policy management and automation capabilities or the equivalent can be utilized. In an Information Technology Asset Management (ITAM) view, assets include servers, switches, NIC cards, software licenses, users, keys, etc. Another set of assets may include passenger scanning devices (e.g., metal archways, mm-wave portals, etc.), security cameras, barcode scanners, checked baggage scanners, key-card access points, operators, and passengers. The information that comes from this second set of assets can be formatted so that it can be read by COTS ITAM systems (e.g., Tivoli, HPOpenView, etc.) and/or military C3I solutions. These methods for security and access policy automation greatly reduce both the complexity and cost of the nominal VPN-based solution for TranSec device connectivity.

Over the past decade, vendors and service providers have been fighting over who will own the Transportation Security Network Operations Center (NOC). According to the present invention, the users of the system will. Such users are the many and diverse stakeholders in the transportation security world. Rather than constraining these stakeholders to use a single system optimized to no purpose but forged out of forced cooperation, the instant invention allows each stakeholder to use their own NOC: COTS, military or custom-built. These users are able to use their optimal solution, customized to their unique disciplines to interact with a single, unified source of data and a single, secure means to interact with all assets under management.

According to the invention, a DMI Core™ set of solutions for Aviation Security (AvSec) markets allow diverse groups of stakeholders to work together (inter-operate) with each other as well as with a diverse set of security assets under management in a TranSec application. That is, DMI Core™ provides the Transportation Security (TranSec) customer a single interface for asset data and management. For example, the U.S. military's specifications for how data is to be served up in battlefield operations to multiple mission-critical recipients of that data may be employed.

DMI Core™ can be used in conjunction with a custom system interface or COTS enterprise or IT asset management systems. DMI Core™ is configured to meet the interoperability standards as outlined by the United States Department of Defense and is easily integratable into any standardized database or xml-based management system.

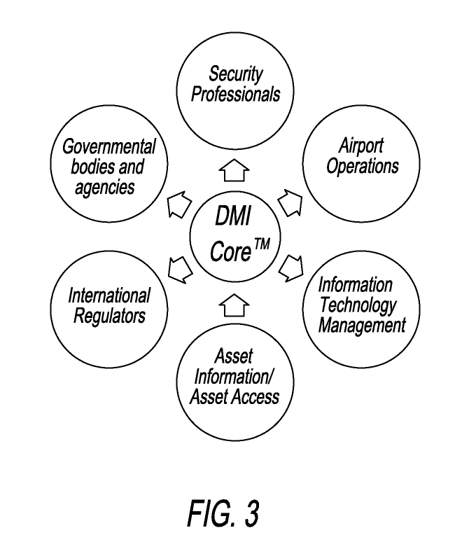

In FIG. 3, the circle labeled Asset Information/Asset Access is an important source of data. At each of the remaining circles there is a unique set of users or stakeholders who have a particular need for a subset of the data. These users might also have a particular group of applications that they use to take in the data, process it and represent it in a useable and meaningful form. In this case, what a meaningful form is would be determined by the discipline represented. Then, at each of the blue circles, there might be some additional information that needs to be sent back to the red circle. For example, in response to an increased threat level at the airport, the security professionals may push out an update to all of the algorithm settings for all scanners represented in the red circle. Finally, there may be some information that needs to go from blue, back to other blues. A government agency may identify an individual as a high threat. They may need to have this information sent out a certain subset of the stakeholders (e.g., security professionals, international regulators, etc.) and with the same action, transmit that information to assets that reside in the red circle. For example, they may send the file representing the facial features of the individual to face recognition software that resides on the intelligent cameras in the airport.

For a TranSec application, the system can be configured to deliver interoperability solutions in two parts. First, each solution begins with deployment of a set of security-hardened hardware and software that provides vendor-independent access to the customer's security assets—whether networked or standalone. Second, at least one use of the interoperability solution is also deployed. These interoperability solutions can be configured with stand-alone application interfaces or as a set of features integrated into existing COTS (Commercial-off-theshelf) NOC (Network Operations Center) solution applications. For the IT professional, the system provides access to previously isolated network segments—independent of a vendor's proprietary network architecture—so that commercially available technology and industry best practices for ITAM (Information Technology Asset Management) may be used to monitor, maintain and secure AvSec-related IT assets within an airport, or across many airports. For example, the system solutions enable the IT professional to enhance the posture of all devices that comprise the customer's security systems; conduct assessments of the security assets being managed; calculate the remaining expected life of network-and IT-related components of the security system; and rapidly deploy policy modifications with security services for red team events.

For the security professional, the system provides a common interface for management of AvSec asset operations such as: (1) Configuration Management (e.g., software version, algorithm settings, patches, etc.); (2) TIP Management (library update deployments, TIP server settings, operator performance reports); (3) Image Archiving (centralized image archiving for all systems, bag image “trace route” linked to IATA license plates); (4) Remote Operator Image Review; and (5) Lifecycle Asset Management and Maintenance SLA compliance for security assets via integration with COTS Enterprise Asset Management (EAM) tools.

Secure deployment of a DMI Core™ solution, according to one embodiment, consists of physically integrating the security assets in a Virtual Service Infrastructure (VSI) network. The tangible assets include: the deviceWISE™ and secureWISE™ VSI hardware components; a set of servers to manage policies, access and status messages; and a database. Three servers may be used to provide the added security of being able to locate the administrator (the one that controls access) in a physically distinct location from the manager (the server that actually provides connectivity after the access policies have been confirmed) and physically distinct from the storage of the data. The administrator and manager softwares may be provided by ILS Technology LLC (Boca Raton, Fla.) and may run on stand-alone servers. The additional software for the storage may be obtained from vendors such as HP, Microsoft, and SolarWinds to make the storage solution.

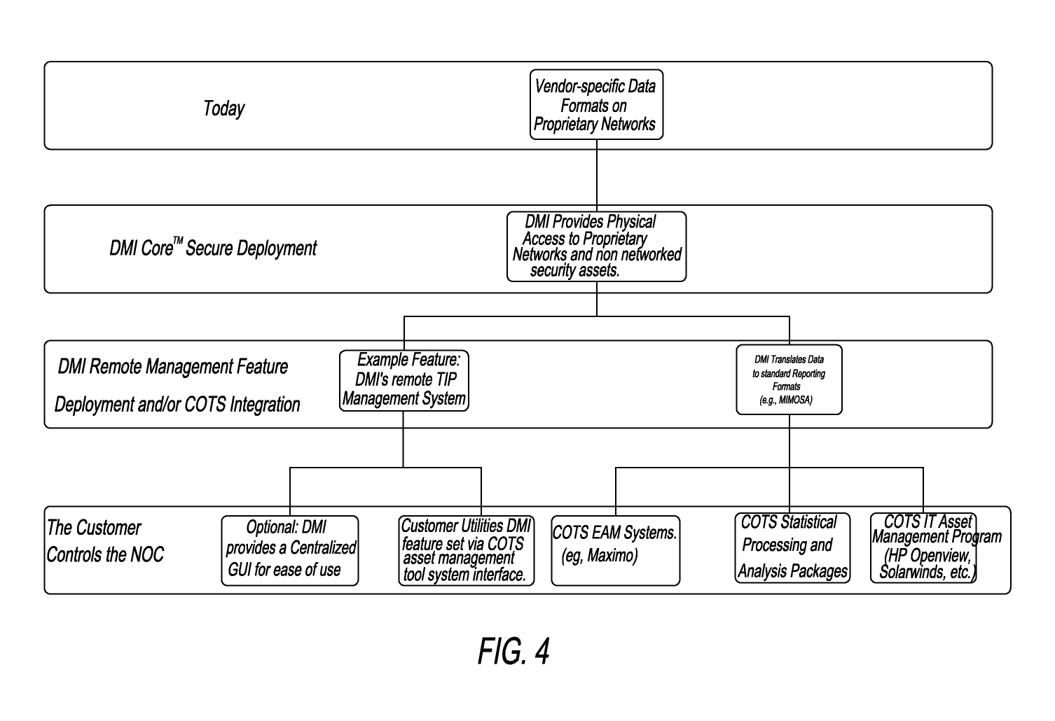

Finally, deployment of a solution should be associated with an interoperability deliverable. That is, once access is established, the information is to be used by at least one Remote Management Feature and the Common GUI or be integrated into a COTS management system selected by the user, as illustrated in FIG. 4.

Deployment of one or more Remote Management Features consists of providing the management capabilities required by users. In a typical engagement, the user identifies each stakeholder team and the managerial capability required by those teams. For the security professional, a library of common, security-related management tasks such as system status, configuration management, centralized image archiving and recall and TIP management can be provided to assist users in meeting the regulatory requirements of a variety of international and national agencies. These features can be made available via the Common Interface GUI or via a variety of COTS asset management tools. Integration with commonly available commercial tools has low technical risks, due to adherence to open and common data object models. For the IT professional, the system includes integration with the current ITAM tools and policies. In order to maintain a high-level of security for each solution deployment, the system may include a configuration change alert feature of a Configuration Management tool set.

The TranSec industry has undergone a radical transformation since the first deployment of networked security devices by the UK following the bombing of PanAm flight 103 over Lockerbie, Scotland in 1988. For the most successful security asset OEMs, a large installed base of equipment may represent a variety of fundamentally incompatible network architectures and stand-alone devices. The engineering required to transform these disparate systems is often cost-prohibitive and distracting from vendor core-competencies.

The invention is able to interface with both legacy and existing systems and produce a single, unified system interface for an OEM's suite of products. The interoperability solution for users typically consists of development of an Application Programming Interface (API) that translates status messages from the legacy and/or proprietary format to a secure and encrypted common format, such as Simple Network Management Protocol (SNMP-3).

The use of a messaging system such as SNMP-3 has several advantages for the OEM provider. First and foremost, it allows the OEM—large or small—to deliver a “plug and play” interface between their products and the best-of-breed asset management systems for a variety of disciplines. The API is as useful to the Airport Operations Manager running an SAP asset lifecycle management system as it is to the IT professional using a CISCO management suite to monitor the network switches and interface cards for evidence of a soft attack on the airport network.

Second, by producing the interoperable data via a secure and encrypted API, the OEM is able to lock-down commercially sensitive data without impacting the user's ability to manage devices. Customers receive messages compliant with PAS 55 or ISA 95, but not proprietary information that went into producing those messages. The OEM is able to deliver the long list of interoperability feature requests that have commonly circulated in the industry by leveraging existing technology.

Currently, the OEMs have various proprietary log files and error messages that they use in the operation and servicing of their equipment. Most of these messages are currently transmitted in plain text or some easily decryptable open standard (e.g., html, xml, snmp). This causes problems for the OEM. For example, users who had accessed these files (intended for OEM use only) have questions about the meaning of the error messages. In some cases, users established tracking systems on their own to try to correlate OEM error messages to systemic failures. OEM are left in the costly and unfortunate position of having to prove that correlation is not causality. It would be better if the OEM were able to filter legacy system massages and present them to customer applications in a meaningful way, without having to alter the system software.

The customer is not interested in the proprietary messages per se. Rather, they need standardized information in a useable format. For example, they need to know that the systems they purchase provide sufficient information to manage under an enterprise asset management system that complies with the PAS 55 or ISA 95 standards. That is, they need to know that sufficient data is present and available in order for the security assets to be professionally managed in an enterprise asset management system.

Further, there is a security risk associated with messages—whether they are explicitly security related or are maintenance-related—being intercepted by criminals (e.g. terrorists, thieves) For example, the jewels from the Duchess of York were stolen from her luggage because the bag tag information related to her suitcase and the x-ray image showing the presence of jewels were accessed by criminals. Another example of a threat is the theoretical threat that terrorists might cause all baggage scanning systems to shut down, causing a large passenger overflow in the airport lobby and providing a terrorist with an “enriched” target of an airport full to the brim of delayed passengers.

According to the system of the present invention, installed hardware and/or software “listens” on the legacy OEM systems or networks for error messages. With the OEM, the system establishes a translation key so that messages that are relevant to PAS 55 and/or ISA 95 management are identified and formatted in the appropriate way xml, MIMOSA, SNMP, etc. The translated messages are digitally signed encrypted and broadcast to the associated systems (the blue circles in FIG. 3).

The encrypted message may contain one or more levels of encryption. That is, a single message may have a header that is plain text. It may have a subheader that is decryptable by all systems that are authorized by policy to descript the signed message. It may further have a sub part that can only be decrypted by a subset of systems. For example, the security professionals or regulators may be the only systems in the overall network of systems where the passenger identifier may be decrypted and used to associate passenger baggage screening results with a passenger ID. Further, the decryption of this part of a message may require some particular set of actions and additional policy checks before it is actually decrypted by the authorized system. For example, a warrant may need to be electronically signed by a judge in the relevant jurisdiction. Note that there is a similar concern over privacy related to the operator performance statistics. The system may allow an operator's performance statistics to be viewed only when the operator himself has logged in to the system.

The translation key can be a transliteration analog or something more complex. In one embodiment, the system can add some intelligence to detect when—for example—a combination of OEM messages that together have a specific PASS 55 or ISA 95 meaning have occurred. The ability to time-shift in the DMI Core application is very important. Messages are built up and alarms are generated based on connections that are made over time. A machine learning capability to this translation capacity can be included, as well. In this embodiment, the system can record all the messages received, how they were translated, and have an ability to instruct the machine learning algorithm as to whether or not that translation was correct. In some cases, the system can provide for manual intervention of a translation. In others, the system can simply say “not correct, re-learn or re-try”. The system can have a built in capacity to simulate translation of the list of original messages. That is, from the recorded store of real OEM messages, there is the ability to “re-send” re-translated messages to the DMI-Core application.

There is also an optional ability to manually add new events and associate messages with a historical record of what occurred from sources that may not be mechanical or electronic for example, operator actions, part replacements, etc. These records can be incorporated in a way that the machine learning system can associate these manually entered events with the OEM machine messages and the system interpretations.

The OEM is able to deliver all of these interoperability and scalable network features without adding to engineering overhead. The system certifies interoperability and the message content and the third party asset management solution providers are responsible for the customization of reports.

Today, security screening assets remain isolated as standalone devices or as a member of proprietary network segments that are not accessible or manageable by modern network management techniques. International efforts to require airport screening device vendors to adopt a single common network architecture have been faced many obstacles. The operation of networked screening devices in a working airport requires precise control over issues of network latency and packet loss on individual network segments. And, vendors have adopted certain network architectures over a period of ten years for valid design reasons and have adapted their hardware and software development to these architectures.

The Virtual Service Infrastructure (VSI) technology according to the invention, enables the use of a single secure WAN as an efficient transport infrastructure to perform advanced proactive monitoring and on-demand access to devices located on remote, disconnected and architecturally distinct security asset network segments.

Forced cooperation on a common network architecture for security devices has two key disadvantages for the TranSec customer or regulator. First, it proscribes design in a slow-to-change standard. Vendor competition for network architecture improvements is eliminated and the customer fails to benefit from this competition. Second, when operational messages must be translated across operational networks, this moves accountability for network latency issues to the customer. By allowing vendors to maintain their independent architecture, the invention relieves the user of these design-related responsibilities and makes clear the Service Level Agreement relationship between security asset vendor and customer.

Where systems are networked, the enhanced Virtual Service Infrastructure (VSI) technology interacts with the proprietary network segments on OSI-layer 2 (at the switch) and requires no modification of network architecture. Operating via a secureWISE VSI-gateway, the invention collects and relays network messages via a separate reporting network. Thus, the security operations on the vendor-specific network segments are unaffected. The responsibility for operational network latency and packet loss remains with the security device vendors while Command and Control network latency and packet loss responsibility remains with the provider.

According to the ILS's description about their technology, which is utilized in the present invention, where systems and additional sensors are not networked on proprietary network segments, deviceWISE™ technology may be used to convert legacy equipment to network appliances on the Command and Control network. Enhanced deviceWISE™ Technology physically connects with systems via legacy connections from PLC to relay. The deviceWISE™ equipment records the signal-based interaction of the equipment, formats the information in a commonly adopted massaging format (e.g. SNMP-3) and transmits the information to the customer NOC via connection to the data source.

There are particular concerns of users in the TranSec market. These security concerns are central in the design of the invention. First, deployed solutions should be able to resist an attack based on compromise of a single individual within the security team. Second, they enhance the security profile of the user location. And finally, they employ current best practices to prevent soft attacks on the system as a whole.

A centralized access and management solution for a TranSec application should anticipate an attack based on compromise of an individual cleared to operate within the system. Solutions that do not include a method of .ductile. rather than .brittle. failure of a security system present an attractive target for the criminal formulating an attack plan. In doing so, these systems effectively paint a target on the backs of cleared individuals and their families and put their lives and the traveling public in danger.

The invention utilizes blind, mutual consent to authorize direct access to and modification of security assets. In order to access the system, a cleared individual submits a request to the VSI system via DMI Core. This request includes what type of access the individual is requesting and the individual.s roles-based access control (RABC) information. Based on these two sets of information, the VSI system submits a request to a manager at the clearance level appropriate to the request. The particular manager that will approve the request is determined at random from a list of appropriate individuals. That is, the individual requesting access does not know who will approve their request. In order to compromise the system, a criminal would have to abduct or influence a cleared individual and potentially each and every manager who might be assigned to approve the request by the VSI system.

All activities associated with Directed Circuits™ are logged in the VSI administrator. For example, any time someone accesses a device, who the accessing entity is and what activities the entity undertook are logged. Directed Circuits™ logging tracks the parameters associated with a Directed Circuits™, including when it was requested, who requested it, its destination, and duration. Logging information is available on standard reports, directly from the VSIadministrator, or from an export feature. Directed Circuits™ logs provide an audit trail which can assist in user compliance to regulatory requirements, such as Sarbanes Oxley Regulations.

All technology employed can be designed to comply with FIPS 140-2 Level 2 encryption, at a minimum, and can be designed for third party certification to FIPS 140-2 Levels 3 and 4.

The system may optionally include standard, proven protocols to ensure the highest level of end-to-end security and authenticity. SSL is used to encrypt and transport the VSI heartbeats and IPsec-based remote device connections between the VSIgateway™ (whether that gateway addresses networked equipment or deviceWISE™ standalone systems) and the NOC. The VSI heartbeats are the output of a VSI gateway™. These heartbeats can be used to communicate with a remotely located management system through the Internet.

The utilization of IPsec over SSL provides for authentication and encryption at the IP (Internet Protocol) level. Additionally, the dual channel closed system (SSL and IPsec) combination guarantees the authenticity of the connection and a higher level of security assurance.

The system can incorporate the following security standards and policies: (1) Encapsulating Security Payload (ESP)—The encryption in the ESP encapsulation protocol is done with block cipher. VSI's block cipher is 3DES; (2) Internet Key Exchange (IKE)—The IKE protocol sets up IPsec connections over the SSL VSIpathway after negotiating appropriate parameters; (3) VSI utilizes distributes unique key with each session, eliminating risk of reuse; and (4) Two-Phase IKE Negotiations—VSI uses a custom matched pair system using 2192 bits per key.

All targeted asset and device monitoring information can be transported within encrypted HTTP packets-based heartbeats over SSL. For on-demand direct access, VSI's DirectedCircuit™ technology utilizes IPsec encryption that encrypts everything in the session between two hosts.

Each VSIgateway has a digital certificate assuring approved recognition by the system located at the NOC. The on-demand Directed Circuits. traverse a SSL connection between the VSIgateway and a VSImanager located in the NOC, thus adding an additional layer of security to the connections.

VSI provides a unique method to ensure security to the enterprise network for both proactive monitoring and on-demand network device access. It does this by utilizing a “push” method, where all communications are securely initiated and driven from the customer site and sent to its associated VSI collection application located in the service provider's Network Operations Center (NOC). This allows for remote monitoring without the concern of security vulnerability due to inbound holes placed in firewalls between the enterprise network and the NOC.

VSI utilizes standard Secure Sockets Layer (SSL) technology as the connectivity component of its “push” functionality. Two SSL connections are established outbound from a remote located VSIgateway (appliance or software) to the NOC: (1) A periodic “heartbeat” used for the delivery of proactive monitoring information such as ping response status, and SNMP traps; and (2) A lightweight carrier tunnel called a VSIpathway used for the delivery of advanced monitoring data, along with remote device connectivity transport. (DirectedCircuit).

The remote device connectivity functionality of VSI allows an authorized support engineer to setup an on-demand and secure IPsec-based session to the device (and only that device) from the NOC. Similar to VSI's status heartbeats, remote device connections are initiated by the VSIgateway—again requiring no open inbound holes in the firewall of the enterprise network, and traverse the SSL-based VSIpathway tunnel which provides an additional layer of encryption to each session.

Each remote device connection has unique dynamic routing policies and rules that lockdown the session between the remote device and the authenticated engineer eliminating the access risk to unauthorized network devices on the enterprise network. Upon completion of a connection session, the connection is closed, leaving no risk for reuse by man-in-the-middle attacks. This closed architecture ensures users that visibility and access to their critical network elements are restricted only to authorized support personnel. The VSI solution also utilizes policy-based access (Internally or via external RADIUS) to ensure only the authorized personnel are allowed access to the system and onto the remote device.

Through the use of symmetrical keys, all communication between the VSIadministrator and its associated modules is performed in a secure .closed” method, thus assuring that no rogue devices can recognize or communicate with any of the VSI modules. The use of a single-session key with every session may also ensure that no “man in the middle” attacks can be performed, as the system will not recognizes/accept any reused keys.

A signature may be set up between machines (where possible) and, where not possible (if software cannot be altered on OEM machines to handle signatures and source checking), a central data-cop role can be created for the policy server. In an operational network (with legacy equipment) that does not handle digital signatures, devices are inserted into the legacy network that pass the messages along as they receive them. As a result, the legacy network is unaware of the change. But, at each node where these devices are inserted, the system reports out messages to a second network (the VSI network, for example). The messages that are reported out via the secondary network are digitally signed and verified at each node. A central policy data cop watches over these digital signatures and verifies at each place where it intersects the legacy network that the messages continue to match the expected values. In this way, an audit trail and a layer of security are added. In the data cop role, the messages can be altered as they are passed in a secure manner.

On the secondary network, there is a windows onto the legacy network. Each window device reports what it “saw” pass by on the legacy network and it digitally signs its report. Since the new or secondary network can handle digital signatures, the source of the information can be ascertained to be authentic. One way to implement this functionality is described below. At the dry-contact relay (or similar legacy connections such as a PLC, RS 422, etc.), a devicewise device is connected between the sending and receiving systems. The device wise device is designed to pass the information along in such a way that its presence is unnoticed on the legacy system. But, in addition to passing the information along to the legacy receiver system, the devicewise device also reports that message out to a second network or a “new” network. A security feature, such as the FIPS level-4 enclosure, is added around these connections (i.e., the connection from sending device to devicewise device to receiver device are secured in a tamper-proof container). These containers may be designed to self-destruct in the case of tampering (e.g., with thermite or other such components, for example). Now the user has some degree of certainty that there has been no physical interference with a message received from a devicewise system. An ability to digitally sign the data that the “new” network receives from the devicewise devices is further added.

As a result, on the new network, there can be an accurate windows onto the legacy network. The source and the intermediate destinations of the messages can be known and tampering with the messages between observation points on the network can be detected.

### EXAMPLE

Attached as Appendix 1 and incorporated by reference herein is a table presenting a set of system requirements and corresponding sets of system features and associated engineering steps to implement an exemplary transportation security system in accordance with one embodiment of the invention. Certain functionality can be provided by software available from ILS Technology, LLC, located in Boca Raton, Fla.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An interoperability system provides Roles Based Access Controls (RBAC) for access and control of disparate security devices, spanning multiple vendors, building locations, and remote locations as if they were on a shared local network, but with addition access controls that support the diverse needs and requirements of varied user constituency groups.

2. The system of claim 1, wherein the security devices from multiple vendors are traditionally not networked together on a shared network and RBAC must be employed to ensure that user constituency groups who require access to specific vendor platforms (Hardware Providers and System Integrators) but not other vendor hardware platforms are only granted access to the specific devices and network communications protocols that are appropriate for their prescribed use and those uses are recorded for auditing purposes.

3. The system of claim 1, wherein the security devices from multiple vendors are traditionally not networked together on a shared network and RBAC must be employed to ensure that user constituency groups who require access to specific operational performance data (number of available devices, number of bags/hour, number of passengers per hour, number of bag rescans, etc) can obtain such access without providing access to other data sources or facilities of the endpoint device using network communications protocols that are appropriate for their prescribed use and those uses are recorded for auditing purposes.

4. The system of claim 1, wherein the security devices from multiple vendors are traditionally not networked together on a shared network and RBAC must be employed to ensure that user constituency groups who require access to management features of the devices to control internal counters, set system level date and time, update firmware revisions, update software revisions, and update operating thresholds or algorithms and the like, can obtain such access without providing access to other data sources or facilities of the endpoint device using network communications protocols that are appropriate for their prescribed use and those uses are recorded for auditing purposes.

5. The system of claim 1, wherein security devices that is legacy/non-networkable from multiple vendors are traditionally not available on a shared network, a combination of hardware bridging of PLC or RS-232/RS-422 to secure TCP/IP based communications to provide RBAC must be employed to ensure that user constituency groups who need configuration and operational performance details from said devices can obtain such access without providing access to other data sources or facilities of the endpoint device using network communications protocols that are appropriate for their prescribed use and those uses are recorded for auditing purposes.

6. An interoperability system provides a unified view of data collected from disparate sources. The software will use a combination of traditional middleware tools functionality and proprietary transformations to enable the data that support multiple “business objects” such as passengers, bags, and cargo being processed for transportation to be collected from the disparate sources including different vendor devices and platforms, into a homogenous Common Object Data Model where existing industry standards do not exist.

7. The system of claim 6 above, wherein vendor devices are capable of a networked connection and data supporting multiple business objects must be collected and transformed to support the needs of the varied user constituency in a secure and auditable manner.

8. The system of claim 6 above, wherein vendor devices are not natively capable of a networked connection and data supporting one or more business objects must be collected and transformed to support the needs of the varied user constituency in a secure and auditable manner.

9. An interoperability system provides access to collected information using tools known in the art of ITAM (IT Asset Management) and Network Operations. Data collected and transformed into the common data object model may have alternative uses in Commercial-Off-The-Shelf (COTS) applications that leverage prevailing network management standards like SNMP.

10. The system of claim 9, wherein data collected from natively networkable devices of claims 2, 3, and 4 and non-natively networkable devices of claim 5 where data collected and transformed can be reused or repurposed and presented to COTS applications using prevailing standards, enabling standard COTS applications to access information and events that would not have been previously enabled for such access.

11. The interoperability system having implementing complex event processing capabilities to enable additional operational and security analysis.

12. A system of claim 11 above, wherein data of disparate types or sources (Staff Schedule, User Logins, Login Failures, Multiple Location logins, Building Access Controls, System Configuration Changes etc) are used to assess potential threats beyond the scope of a single passenger or parcel passing through the system which is the current scope of the devices and software of the art today.

13. A system of claim 11, wherein data of disparate types or sources can be correlated to external data sources with dynamic links to those sources. In this embodiment, an “Alert” may be generated if a staff member is not scheduled to be on shift, has not passed through the access control system, and the UserID has an unsuccessful login attempt. This alert could generate a link to Digital Video Surveillance system, to look at the grouping of cameras in the area of concern at that point in time. In this use case, the security data is collected by the system, but the Survelance system data is not, but a ‘pathway’ is define to quickly link to the relevant information in that system.

14. The system of claim 1 further provides solution for users comprises development of an application programming interface (API) that translates status messages from the legacy and/or proprietary format to a secure and encrypted common format, such as Simple Network Management Protocol; the encrypted message contains one or more levels of encryption; the decryption of some parts of a message may require some particular set of actions and additional policy checks before it is actually decrypted by the authorized system.

15. The system of claim 1 further has an ability to manually add new events and associate messages with a historical record of what occurred from sources that may not be mechanical or electronic; the records can be incorporated in a way that the machine learning system can associate these manually entered events with the original equipment manufacturer (OEM) machine messages and the system interpretation.

16. The system of claim 1, wherein a signature may be set up between machines (where possible) and where not possible (if software cannot be altered on OEM machines to handle signatures and source checking), a central data-cop role can be created for the policy server to ensure an audit trail and add a layer of security.
